(19) United States
(12) Patent Application Publication
(10) Pub. No.: US 2024/0184714 A1
(43) Pub. Date: Jun. 6, 2024

(54) CryptoMMU for Enabling Scalable and Secure Access Control of Third-Party Accelerators

(71) Applicant: North Carolina State University, Raleigh, NC (US)

(72) Inventor: Amro Awad, Raleigh, NC (US)

(21) Appl. No.: 18/529,669

(22) Filed: Dec. 5, 2023

Related U.S. Application Data
(60) Provisional application No. 63/430,559, filed on Dec. 6, 2022.

(51) Int. Cl. G06F 12/1018; G06F 12/1027

(52) U.S. Cl. CPC G06F 12/1018; G06F 12/1027

(57) ABSTRACT

Various examples are provided related to access control of accelerators. In one example, a method for cryptographic memory management includes receiving, by a cryptographic memory management unit (CryptoMMU), a request identified as a private translation-lookaside buffer (TLB) miss or hit from an accelerator; in response to the TLB hit, generating a message authentication code (MAC); comparing the generated MAC to a MAC provided with the request; and in response to the comparison, allowing system memory access if the generated MAC matches the MAC provided with the request. In another example, a system can include a processing or computing device that can receive, by a CryptoMMU, a request identified as a private TLB miss or hit from an accelerator; generate a MAC in response to the TLB hit; compare the generated MAC to a MAC provided with the request; and allow system memory access in response to the comparison.

### CROSS REFERENCE TO RELATED APPLICATIONS

This application claims priority to, and the benefit of, co-pending U.S. provisional application entitled “CryptoMMU for Enabling Scalable and Secure Access Control of Third-Party Accelerators” having Ser. No. 63/430,559, filed Dec. 6, 2022, which is hereby incorporated by reference in its entirety.

### BACKGROUND

Due to the increasing energy/performance gap between general-purpose processors and hardware accelerators, there is a clear trend for leveraging custom hardware accelerators in edge devices, cloud systems, and data centers. Whether discrete, integrated on-chip, re-configurable (e.g., FPGA), or rigid (e.g., ASIC-based), a large number of accelerator options are available for important workloads. System integrators and customers should have the flexibility to deploy custom accelerators based on their performance, power, area, and price constraints. Such integration can be as early as at design time when third-party intellectual properties (IPs) are used, at integration time when third-party discrete chip accelerators are used, or during operation as in re-configurable logic. A major concern that arises when deploying such accelerators is system security due to the increased attack surface. Specifically, many of these accelerators leverage programming models where they can collaboratively access and process the data in the host's main memory. Accordingly, a malicious accelerator can compromise the whole system by accessing other processes' data, overwriting OS data structures, etc.

### SUMMARY

Aspects of the present disclosure are related to access control of accelerators. In one aspect, among others, a method for cryptographic memory management comprises receiving, by a cryptographic memory management unit (CryptoMMU), a request identified as a private translation-lookaside buffer (TLB) miss or hit from an accelerator; in response to the TLB hit, generating a message authentication code (MAC) based upon attributes of a page table entry (PTE) corresponding to the request; comparing the generated MAC to a MAC provided with the request; and in response to the comparison, allowing system memory access if the generated MAC matches the MAC provided with the request. System memory access can be denied if the generated MAC does not match the MAC provided with the request.

In one or more aspects, the request can comprise the attributes of the PTE. Generating the MAC can comprise determining a key from an authentication key table (AKT) based at least in part upon a device identifier (DevID) associated with the accelerator and a process address space identifier (PASID). In various aspects, the method can comprise, in response to the TLB miss, obtaining a page table entry (PTE) based upon a page table in host memory corresponding to the private TLB miss; determining message authentication code (MAC) based upon attributes of the PTE; and providing the accelerator with translation information comprising the PTE and the determined MAC, the translation information enabling access by the accelerator. The PTE can be obtained by walking through the page table.

In another embodiment, a system for cryptographic memory management, comprises at least one processing or computing device comprising processing circuitry, the at least one processing or computing device configured to at least: receive, by a cryptographic memory management unit (CryptoMMU) of the at least one processing or computing device, a request identified as a private translation-lookaside buffer (TLB) miss or hit from an accelerator; in response to the TLB hit, generate a message authentication code (MAC) based upon attributes of a page table entry (PTE) corresponding to the request; compare the generated MAC to a MAC provided with the request; and in response to the comparison, allow system memory access if the generated MAC matches the MAC provided with the request. System memory access can be denied if the generated MAC does not match the MAC provided with the request.

In one or more aspects, the request can comprise the attributes of the PTE. Generating the MAC can comprise determining a key from an authentication key table (AKT) based at least in part upon a device identifier (DevID) associated with the accelerator and a process address space identifier (PASID). In various aspects, the at least one processing or computing device can be configured to: in response to the TLB miss, obtain a page table entry (PTE) based upon a page table in host memory corresponding to the private TLB miss; determine message authentication code (MAC) based upon attributes of the PTE; and provide the accelerator with translation information comprising the PTE and the determined MAC, the translation information enabling access by the accelerator. The PTE can be obtained by walking through the page table. A trusted computing base can comprise the at least one processing or computing device.

In another embodiment, a non-transitory computer-readable medium embodying a program executable in at least one computing device, where when executed the program causes the at least computing device to at least: receive, by a cryptographic memory management unit (CryptoMMU) of the at least one processing or computing device, a request identified as a private translation-lookaside buffer (TLB) miss or hit from an accelerator; in response to the TLB hit, generate a message authentication code (MAC) based upon attributes of a page table entry (PTE) corresponding to the request; compare the generated MAC to a MAC provided with the request; and in response to the comparison, allow system memory access if the generated MAC matches the MAC provided with the request. System memory access can be denied if the generated MAC does not match the MAC provided with the request.

In one or more aspects, the request can comprise the attributes of the PTE. Generating the MAC can comprise determining a key from an authentication key table (AKT) based at least in part upon a device identifier (DevID) associated with the accelerator and a process address space identifier (PASID). In various aspects, the program, when executed, can cause the at least one processing or computing device to: in response to the TLB miss, obtain a page table entry (PTE) based upon a page table in host memory corresponding to the private TLB miss; determine message authentication code (MAC) based upon attributes of the PTE; and provide the accelerator with translation information comprising the PTE and the determined MAC, the translation information enabling access by the accelerator. The PTE can be obtained by walking through the page table.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a threat model for reconfigurable accelerators, in accordance with various embodiments of the present disclosure.

FIG. 2 illustrates an example of a Border Control implementation, in accordance with various embodiments of the present disclosure.

FIG. 3 illustrates an example of performance of the Border Control approach relative to an ideal unsecure design, in accordance with various embodiments of the present disclosure.

FIG. 4 illustrates an example of CryptoMMU handling of private Translation-Lookaside Buffer (TLB) misses, in accordance with various embodiments of the present disclosure.

FIG. 5 illustrates an example of CryptoMMU handling of private TLB hit, in accordance with various embodiments of the present disclosure.

FIG. 6 is a schematic block diagram illustrating an example of a processing or computing device that can be used for implementation of a cryptographic memory management unit, in accordance with various embodiments of the present disclosure.

### DETAILED DESCRIPTION

Disclosed herein are various examples related to access control of accelerators. Most processor and system-on-chip companies heavily rely on IOMMU to ensure access control of I/O devices and accelerators. To eliminate these security ramifications of using third-party accelerators, a unit similar to a memory management unit (MMU), namely IOMMU is typically used to scrutinize memory accesses from I/O devices, including accelerators. However, due to the limited size of IOMMU, as it needs to reside in the trusted boundaries (e.g., processor chip) and on the critical path of each I/O memory access, IOMMU incurs significant performance overheads. In this disclosure, a novel scheme, CryptoMMU, is proposed which builds on a philosophy to delegate the translation process to accelerators, however, elegantly authenticate the targeted addresses cryptographically. As CryptoMMU enables accelerators to cache their own translations privately, it can provide better scalability. The idea allows companies to implement a highly-scalable solution which provides the same level of security but at a much higher level of scalability by leveraging cryptographic approaches. By allowing I/O devices to securely cache their translations without requiring any changes to the operating system or the I/O devices or accelerators, the proposed IOMMU design allows efficient access control implementation. Reference will now be made in detail to the description of the embodiments as illustrated in the drawings, wherein like reference numbers indicate like parts throughout the several views.

With the increasing diversity of workloads and the significant performance and energy gap when using custom accelerators vs. general-purpose processors, modern accelerator rich architectures are getting traction in cloud systems, edge devices, and HPC systems. Such accelerators are manufactured with different form factors and integration strategies. Varying from soft intellectual property (IP) designs integrated within a system-on-chip (SoC), a design that is used in a re-configurable logic fabric, or a discrete accelerator chip that is integrated using I/O interconnects. For instance, the most traditional way of integration is through common physical layer I/O interfaces and standards, e.g., PCI Express (PCIe). On top of the physical layer, various protocols, e.g., Cache coherent interconnect for accelerators (CCIX), exist and are supported. Additionally, there exist proposals for integrating accelerators as a part of the die, as in recent Apple's M1 Chip, or as FPGAs integrated internally to be reconfigured as accelerators as in Intel's Hybrid Xeon CPUs. While the former approach (discrete accelerator chip) provides system integrators with more flexibility to choose custom accelerators, hence improved ecosystem and cost, the later approach (integrated chip) minimizes the integration overheads.

In either way of integrating accelerators, discrete or integrated on-chip, the processor is generally responsible for preparing and co-processing the data along with the accelerator. Many programming models allow accelerators and CPUs to collaboratively process data leveraging programming models such as OpenCL and CUDA. Similarly, many accelerators leverage the host memory interfaced with the CPU as either an extension or main memory for the accelerator. In all these cases, whether due to the programming model and/or limited resources in the accelerator, there should be a mechanism to allow accelerators to access the host memory directly and efficiently. However, similar to I/O devices, such direct access poses great security risks, of which an accelerator can compromise the whole system. Bugs or vulnerabilities in the device driver, untrusted supply chain, bugs in the accelerated kernel, etc., all increase the attack surface significantly. In fact, even in integrated chips, many of the accelerator's IPs, including reconfigurable ones, are from third-party vendors, perhaps with less rigorous testing and security consciousness/certification.

The Problem: To mitigate the increasing security risks due to the integration of third-party accelerators and I/O devices, modern systems leverage IO Memory Management Unit (IOMMU) which scrutinizes accesses from I/O devices and accelerators and ensures they only access their corresponding memory locations. However, such IOMMUs must be integrated on the trusted chip (i.e., the CPU) and on the critical path of every I/O access to the host memory, including coherence messages. Thus, IOMMU are made to be fast, however small (e.g., tens of entries), to ensure minimal energy and performance overheads on the critical path of I/O and accelerator accesses. On the other hand, with the growing trend for integrating accelerators for memory-intensive workloads, and the expected abundance of memory on the server side, accelerators are expected to throttle the IOMMU. In fact, technological trends such as emerging non-volatile memories (NVMs), such as Intel's DCPMM, integrated with the host and possibly used to host large files, further motivate more reliance on host memory by the accelerators. Moreover, programming models that enable multiple accelerators and the CPU to collaboratively process data rely on host memory as a natural syncing point. Thus, efficient yet secure IOMMU implementation is important for increasing accelerator-rich architectures.

The Challenge: The security and performance of accelerators have been separately explored in prior works. For instance, the inclusion of private Translation-Lookaside Buffers (TLBs) has been proposed to cache address translations to the host memory locations within each accelerator. However, this obviously violates the security goals behind IOMMUs in favor of more scalability and better performance. More recently, Border Control (BC) has been proposed. BC's goal is to improve the coverage and locality of the hardware structures in IOMMU by decoupling translation metadata from access permission metadata. Specifically, BC allows accelerators to complete the translation step privately, however the proposed IOMMU checks if the accelerator has access permissions to the request's physical address. By leveraging a contiguous bitmap-like structure for each accelerator, where each bit (or two) reflects if the corresponding physical page can be accessed (and written) by the accelerator. Thus, the IOMMU can cache and check entries from such a bitmap-like structure to authenticate physical addresses provided by the accelerator. Such a structure, hereinafter referred to as protection table, is located in host memory and hence assumed secure. Unfortunately, BC suffers from scalability, performance, and practicality challenges. Specifically, modern systems deploy a relatively large number of physical and/or logical accelerators (e.g., IPs), and an increasing number of applications leverage such accelerators hence the need for multi-context support. More importantly, when the IOMMU is thrashed due to different access streams by accelerators, each access to host memory can require an additional access to the permission table. Thus, BC can incur bandwidth and storage overheads which can limit the system's scalability. Moreover, BC changes the operating system (OS) to additionally manage (create and free) protection tables, and expose their addresses to IOMMU, which adds complexity to an already complex and critical subsystem in OS and also limits its deployment in systems where the OS cannot be modified easily (or closed source). Consequently, the main challenge to achieve scalable IOMMU implementation is to allow accelerators and devices to cache their own translations yet ensure the performance of address checking at IOMMU is independent of the access pattern/locality of accelerators/devices. Moreover, requiring no software changes besides what is already implemented for legacy IOMMU.

The Solution: To allow accelerators to cache their own translations while ensuring security, the IOMMU checks that the targeted pages can be accessed by the accelerator/device. Solutions such as BC heavily depend on the access pattern and number of interleaving requests from different devices. Specifically, the metadata used by IOMMU to check the ownership of the page requested by the device heavily depends on the (physical address) access pattern, which can consume significant memory bandwidth when a practical number of accelerators are involved. Accordingly, CryptoMMU, a novel IOMMU design that leverages cryptographic means to validate the host memory requests by devices is proposed. Specifically, CryptoMMU allows accelerators to cache their own translations yet verify the addresses provided by them cryptographically. To do that, CryptoMMU provides two designs. The first design can be integrated with future accelerators and leverages separate cryptographic authentication tags that require changes to the accelerators TLB structure, whereas the second design provides high detection probability (improbability of 2.9×10⁻⁸) and works even with legacy accelerators by leveraging truncated lightweight MACs embedded using bits of the physical address in the translation entries.

### BACKGROUND

This section presents background related to the assumed threat model, integration of third-party accelerators, the increased attack surface in heterogeneous systems, common high-performance accelerators, IOMMU design and operation, and message authentication code.

### Threat Model

The assumed threat model closely resembles prior work in secure access control of hardware accelerators. The main purpose of access control is to ensure data isolation between different processes and between the processes and the Operating System (OS) kernel. While the processor is trusted to contain a valid Memory Management Unit (MMU) to ensure isolation between processes, external accelerators (whether discrete chips or design IPs) are numerous and could come from third-party vendors with various trust levels. Thus, an on-chip trusted MMU (e.g., IOMMU) is used to enforce isolation on the memory requests arriving from the accelerators/devices. Although it is impossible to ensure that an untrusted accelerator internally enforces the isolation of the processes' data exposed to it, the accelerator is restricted from accessing any data besides those of the processes using it, and only those pages that are allowed to be accessed by the accelerator. In other words, based on the threat model, an accelerator might access (read or write) pages that they are not supposed to access, either due to a buggy implementation or a malicious component. Thus, the trusted MMU scrutinizing accesses from external/untrusted components should ensure that the accelerators can only access the pages they are authorized to access and write only to the pages they are allowed to write to. Once a process using the accelerator is scheduled, the MMU allows access to the pages of that process, allowing only legitimate access to the accelerator in the host memory.

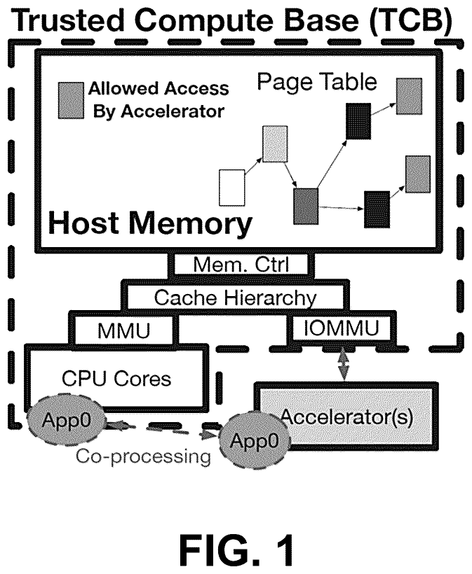

FIG. 1 depicts a sample system integrated with an accelerator. As shown in FIG. 1, the accelerator is allowed access only to the pages of the process(es) currently using it and only to the pages allowed to be accessed by the accelerator. For instance, the process might restrict the accelerator from accessing other pages belonging to the process and hence the IOMMU needs to enforce that. Moreover, the IOMMU will enforce access permissions; for instance, the IOMMU does not allow writes by the accelerator to pages that are marked as read-only. The reconfigurable logic, whether off-chip (e.g., external FPGA board) or integrated on-chip, can deploy third-party designs on demand or per application. Without losing generality, a reconfigurable logic accelerator integrated on-chip can be assumed, similar to prior works. Nonetheless, the study also applies to discrete accelerator chips, whether ASIC-based or reconfigurable accelerators (e.g., FPGA-based). Note that it can be assumed that host memory is inside the trusted computing base (TCB), which can be accomplished through typical memory security protection from external physical attacks or choosing a trusted memory vendor and providing point-point protection as used in ObfusMem and InvisiMem.

### Third-Party Accelerator Integration Strategies

Generally, there are three ways to integrate accelerators. First, at design time, where in this approach third-party accelerators can be integrated into the SoC through standard system buses, such as AXI or PCIe, within the SoC. The third-party design may contain standard RTL source files along with resources to compile the third-party software, device drivers, and other libraries to control the accelerator. On many occasions, these third-party designs are encrypted and can't be tested rigorously for any potential bugs or malicious modifications like Hardware Trojans. Even with the design details, it is infeasible to perform exhaustive explorations of millions of logic elements to detect a possible security threat or bug. Second, at integration time, a discrete accelerator chip from a third-party vendor can be interfaced with the SoC or the processor chip. These discrete accelerator chips could potentially contain bugs or hardware trojans because of compromised manufacturing chains. It is challenging to verify large designs that can trigger hardware trojan with a small number of rare inputs. Therefore, relying on these accelerators to restrict their own access to pages mapped to accelerated processes introduces a high risk and significantly increases the attack surface. Third, during runtime, as in the FPGA-based systems. FPGAs are different from fixed-logic hardware because of the partial or full reconfigurability of hardware on demand. SoC designers can add new accelerators from an Intellectual Property (IP) store. Thus, as users and applications constantly look for new accelerators and IPs that improve performance and energy efficiency, the reconfigurable logic could contain IPs that might come from untrusted sources. Hence there should be a mechanism to scrutinize accesses to shared memory from the reconfigurable logic.

Therefore, there is a need to innovate high-performance SoC designs to sandbox third-party accelerators to minimize the attack surface in accelerator-rich architectures.

### I/O Memory Management Unit (IOMMU)

IOMMU has been traditionally used to provide address translation services to IO devices. Recently, domain-specific accelerators are interfaced with the main memory through I/O MMU. The IOMMU allows the OS to encapsulate the accelerator in its virtual memory space. Accelerators can make requests using IO virtual addresses (IOVA), which are translated to physical addresses at IOMMU, thus protecting the system from a malicious/buggy accelerator. Within IOMMU, there exists an I/O Translation Lookaside Buffer (IOTLB) which caches the translations themselves, page table walking caches (PTWCs) that cache intermediate levels of the page table, and page table walker that fetches the translations when not present in IOMMU. IOMMU resembles the MMU unit used for processor cores, except that it receives IOVA requests from external/internal accelerators instead of CPU cores. Since IOMMU is in the critical path of all memory requests from devices or accelerators, the IOTLB size is traditionally small (similar to regular TLBs). Using multiple parallel IOTLBs is possible but comes at the cost of power, area, and performance. Moreover, in places where a reconfigurable logic is part of the system, accelerator design could be composed of tens of IPs that work collaboratively. Hence assuming parallel IOMMU resources, over-engineered for a maximum number of configurable accelerators is impractical.

In modern I/O interconnect protocols, e.g., PCIe, hardware devices are distinguishable through unique hard-coded IDs (e.g., device/bus/function ID) that is fixed and identified by the port the device is connected to. Although the device ID of requests cannot be provided by the device due to security reasons, modern IOMMUs allow devices to additionally augment the requests with a Process Address Space ID (PASID), which is typically a 20-bit identifier. By using PASID, accelerators and devices can allow multiple processes to use the device/accelerator concurrently. Although IOMMU cannot ensure data isolation within the device, however, it allows the device to rely on IOMMU to ensure isolation between processes using the same device when accessing the host memory. Thus, at any point in time, a device can have multiple processes distinguished through its PASID, and the different devices are distinguished by the hard-wired device ID (i.e., dev/bus/fun ID in PCIe). Without losing generality, a similar configuration can be assumed for reconfigurable logic accelerators where different explicit ports are designated using specific hard-wired IDs and hence recognizable by IOMMU.

Each PASID is typically paired with an actual process in the host, and hence upon access that misses in IOMMU, the page table corresponding to that PASID will be walked to obtain the translation. However, there are different ways to realize the page table corresponding to PASID, private page table or shared page table. The private page table approach works by having a separate page table for the same process, one for the device while the other is for the CPU. The device page table, walkable by IOMMU and residing in the host memory, is populated by the operating system and the device driver of the device either on-demand or upon certain calls (e.g., CUDA memory allocation calls). The limitations of this approach include storage overhead, the complexity of supporting a unified memory model and coherence, and the page fault overheads when populating the table on demand. On the other hand, the shared page table approach allows using the same page table used by the process running in the host and hence allows simpler ways to realize unified memory models and minimize the overheads for managing two separate page tables.

Similar to prior work, a shared page table model was assumed. In other words, the workloads treat the accelerator as a hardware thread that can run threads coprocessing the data along with other CPU threads. However, CryptoMMU can also be used with the private page table model without any changes.

### Message Authentication Code (MAC)

MAC is commonly used to verify the authenticity of data transmitted over a network, bus, or stored outside the trusted computing base. MAC relies on a symmetric key which is used to generate digests by applying a one-direction hashing function over the shared key and the message. MAC uses the symmetric key to verify the authenticity of the data; since the key is kept confidentially, any attempt to manipulate data will fail to generate a MAC that can authenticate such data. Thus, when such data is fetched along with its MAC, the verification will generate a MAC based on the data and compare it with the one provided. Hence, only data that has been authenticated and have a legitimate MAC can pass the verification check. More formally, H=MAC (Key, D), where D is the data and Key is the authentication key. Thus, if D was tampered with, i.e., changed to D′, upon verification, the resulting MAC H along with D′ will not match, H≠MAC (Key, D′), and thus the check fails. Therefore, unless the attacker can produce a H′ that is equal to MAC (Key, D′), the test will always fail. However, since the attacker does not know the key, they cannot generate such value, and hence any tampering will be detected. MAC values are generally large enough, e.g., 56 or 64 bits, to ensure negligible collision probability. Examples of MAC algorithms include SHA-256 or the Carter-Wegman MACs generally used in the AES-GCM scheme. For the rest of this disclosure, when referring to using MAC, it is assumed to be a MAC based on Carter-Wegman similar to that used in Intel's SGX.

### Motivation

Since IOMMU must be within the trusted boundaries and in the critical path of all memory accesses from I/O devices, its size is limited to achieve minimal lookup latency and power/area efficiency. However, with the significant increase in using accelerators and the increasing interconnect bandwidth, the IOMMU can be considered a major bottleneck in accelerator-rich architectures. Thus, recent I/O interconnect protocols allow devices/accelerators to internally cache their own translations and hence directly provide the physical address to the IOMMU, i.e., bypass the IOMMU translation step. Examples of such support include the PCIe's Address Translation Services (ATS) which is leveraged by modern accelerators. Prior works demonstrated the benefits of using such private caching of translations in accelerator-rich architectures. While such a solution provides scalability, it defeats the purpose of using IOMMU from a security perspective. Specifically, if any accelerator/device is malicious, it can compromise the whole system. Relying on accelerators to provide legitimate physical addresses that they are allowed access to expands the attack surface. To allow scalability by allowing the accelerator's internal caching of translations while also ensuring security, Border Control, which aims to improve the locality in IOMMU structures through decoupling translation from access control metadata, has been proposed. Since access control metadata can be as little as two bits per page, to indicate if read/write is allowed by the {accelerator, process}, and thus improve locality in IOMMU.

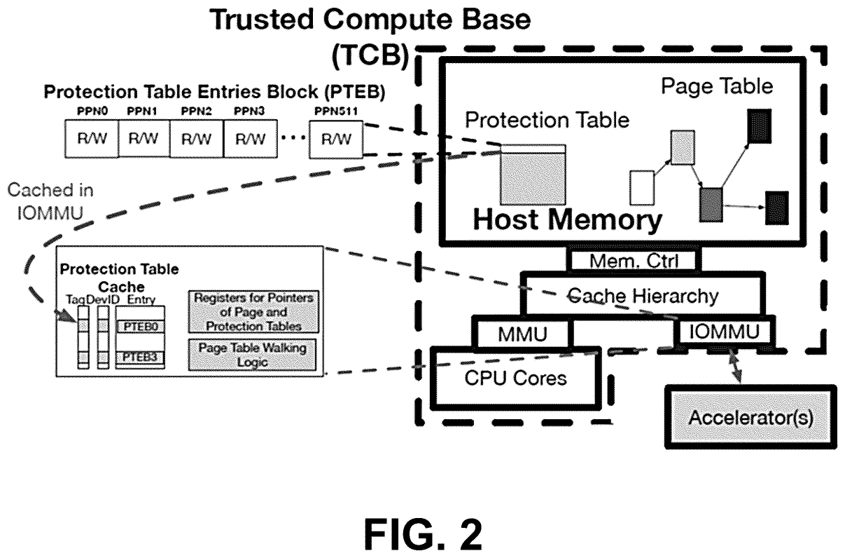

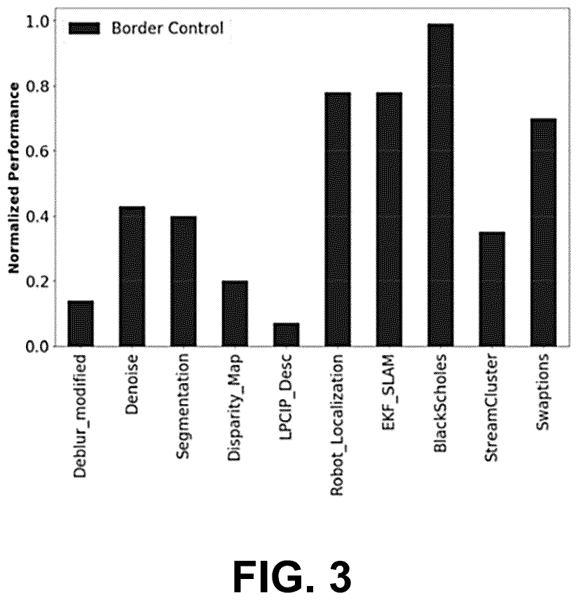

FIG. 2 illustrates a high-level overview of a border control implementation. One protection table for one device is shown, but there could be many. As shown in FIG. 2, accelerators can cache the translations internally and provide the translation to the IOMMU, whereas the IOMMU is responsible for checking if that particular physical address is allowed to be accessed (and written if write request) by the accelerator. Unfortunately, even though the access control metadata (as shown in the Protection Table of FIG. 2) can have high locality, two main performance challenges were observed that limit the adoption of Border Control. First, Border Control still relies on metadata to be cached in IOMMU, and hence the contention increases as more accelerators or memory is accessed. The Border Control Cache (BCC) will be thrashed, and hence extra memory bandwidth is needed. Second, to simplify indexing, as shown in FIG. 2, Border Control's protection tables are allocated in a flat way which is directly indexed by the physical address provided by the accelerator. Thus, even when two accesses are for two contiguous virtual pages, they can map to distant physical pages and hence have far away protection table entries. In other words, the locality of BCC blocks heavily depends on the physical address patterns, which are unpredictable in a real system. Due to these reasons, Border Control can still incur significant overheads compared to a scheme with private caching but no IOMMU checking (i.e., ideal), as shown in FIG. 3. On average, Border control slows down the system by 3.7x.

In addition to the performance and scalability limitations of Border Control, it also introduces other challenges. For instance, each pair of {accelerator, process} utilizes a protection table statically allocated and contiguous with two bits per physical page in the system. Such overheads can be acceptable for a single accelerator with a limited number of processes. However, it can quickly become a bottleneck for systems that run many applications for a long time using the accelerator occasionally or systems with a large number of accelerators/processes. Moreover, Border Control relies on the page table to populate the protection table and hence fundamentally limits the inclusion of page table walkers and page table walking caches within the devices/accelerators. There are many recent efforts and works that show the impact of such logic within accelerators. Finally, Border Control needs non-trivial changes to the OS and its memory management subsystem to create, initialize, and free protection tables. Such changes impact the software path for TLB maintenance operations to additionally update the protection table, and also expose the location of each protection table the IOMMU which also requires changing the device table structure containing the pointers to {accelerator, process} page tables.

Accordingly, based on these observations, efficient IOMMU implementation in accelerator-rich architectures comprises the following: (1) if a translation is cached in an accelerator, the IOMMU should be able to verify the access without the need to bring any extra metadata from host memory, this reduces the contentions that arise due to thrashing of IOMMU's internal caches because of a large number of accelerators; (2) no additional storage overhead such as the contiguous flat tables per {accelerator, process} as used in Border Control; (3) the IOMMU performance is independent from the access pattern of accelerators (i.e., does not rely on having a limited number of devices/processes or close proximity of physical pages for neighboring virtual pages); and (4) no OS changes.

### CRYPTOMMU

To achieve secure, high-performance, and scalable IOMMU implementation, the aim is to achieve the following: (1) if a translation is cached privately by an accelerator, then the IOMMU will not need to bring any other per-page metadata to verify the request; (2) minimal or zero storage overhead for storing additional metadata per page to enable access checking by the host (i.e., IOMMU); and (3) the IOMMU performance is independent of the access pattern of accelerators and hence oblivious to the (spatial and/or temporal) locality of their accesses.

To achieve this, CryptoMMU leverages cryptographic guarantees to enable efficient checking of the physical addresses provided by the accelerators. The CryptoMMU design philosophy builds on the fact that instead of the IOMMU becoming a bottleneck to fetch metadata and verify the accesses of an accelerator, the responsibility of proving the authenticity of a translation can be relegated to the accelerators themselves. Specifically, if the accelerator can prove that they are allowed access to the physical address with the provided access type, then the request can proceed. Otherwise, a violation will be detected. Surprisingly, authentication codes (MACs) were identified as a simple way to prove authenticity. Fortunately, since most accelerators are known to be latency-tolerant, however, bandwidth-demanding, unlike CPUs, the MAC calculation latency for address translation of accelerators can be negligible. In the typical use case of MACs, the authentication tags are used to prove that a message was generated through a trusted party. In such a case, both ends of the communication share a session key. However, since the accelerators are not trusted to provide legitimate translations, such a shared session key approach is inapplicable. On the other hand, unlike authenticating communication, the IOMMU can act as both a signing entity and a verification entity. Since the translation entries cached by the accelerator are provided by the IOMMU upon an internal TLB miss, the IOMMU can calculate a MAC, which could be cached along with the translation and provided by the accelerator to prove the authenticity of the translation.

While MACs are cryptographically secure, they can increase the TLB entry size in private TLBs. Thus, such a solution can be anticipated to influence future accelerators. However, legacy accelerators that are designed with legacy TLB entry sizes (e.g., 8 bytes) cannot be changed to accommodate and also communicate the MAC information to IOMMU along with each memory request. Thus, this introduces a demand for an address authentication mechanism that allows verifying the translation without any extra info provided by the accelerator. Finally, during the lifetime of a process, the page table might be updated, and some addresses could be unmapped. Thus, future access to these pages must be prohibited. However, accelerators caching the translation, along with its MAC, can falsely prove it to be legitimate access. On the other hand, relying on ATS services for sending an invalidation request for such an entry to the accelerator is also not safe, as a malicious or buggy accelerator could (intentionally) not invalidate such a request.

Now understanding the challenges of implementing a scheme based on cryptographic authentication, the details of CryptoMMU will be examined. First, the baseline CryptoMMU, which is targeting future accelerators that can adapt their internal TLB implementations, will be described. Later, another design that introduces no changes to the internal TLBs of accelerators will be described and its security limitations discussed. Finally, how TLB maintenance operations can be handled securely in the CryptoMMU designs is presented.

### Baseline CryptoMMU Design

The baseline CryptoMMU relies on accelerators to provide MACs that prove the authenticity of the translation. The authenticity checking involves two parts: (1) the physical address to be accessed by the accelerator is allowed to be accessed by the accelerator, and (2) the access type for that page is allowed for the accelerator. To prove the authenticity of such two parts, the inputs and the key used to calculate such MAC per TLB entry are defined. An authentication key per accelerator can be used. Since isolation between processes concurrently using the accelerator is enforced internally by the accelerator, it looks redundant to enforce the isolation externally as a malicious accelerator can still leak the information internally. The accelerator is responsible for indicating which process, from those concurrently running on it, is issuing the request. Hence, a malicious accelerator can impersonate a request from another process currently running on it to access other processes. Accordingly, under the threat model, if an accelerator is malicious, it can potentially leak information between processes using it and hence break their isolation.

However, if an honest accelerator is running and relies on IOMMU to provide such checking externally, the IOMMU should support that too. Thus, the authentication key per {accelerator ID, PASID} pair. In other words, even if a process running in an accelerator leverages a hardware bug to attempt access to a physical address of another process also using the accelerator, the CryptoMMU should detect that. The only case where this cannot be detected is if the hardware bug can also enable changing the PASID of the requests originating from the accelerator. Nonetheless, even in that case, CryptoMMU would still achieve the same level of security as a regular IOMMU, which in this case ensures the accelerator can only access the pages it can access irrespective of which process is sending the request (collective set from all concurrent processes using it).

As we now know the key to be used for authentication, the other input to the authentication algorithm is the part to be authenticated. Thus, we opt for choosing the concatenation of the physical page number and access permissions in the page table entry (PTE) as the MAC generation input. In other words, our MAC generation will take the following form:

H_{PTE_X}=MAC(Key_{{AccID,P ASID}},{PPN_{X},R/W_{X}}).

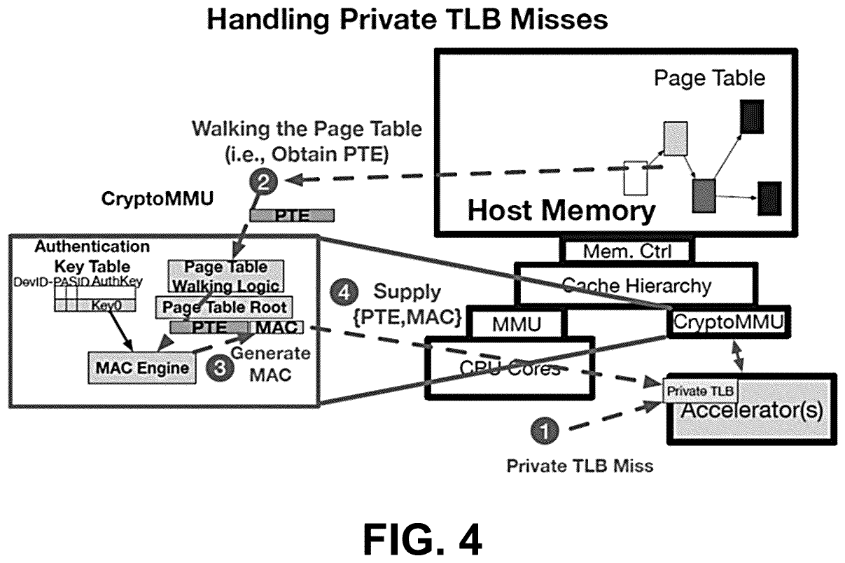

The MAC uses a key that is per {accelerator, process} and takes as input the physical page number (PPN) and the R/W permissions of the {accelerator, process} for that PPN. Thus, as shown in FIG. 4, upon a private TLB miss (Step (1) of FIG. 4) from an accelerator, the IOMMU walks the corresponding page table as usual (as shown in Step (2) of FIG. 4) to obtain the corresponding Page Table Entry (PTE). However, before it provides the accelerator with that entry for future references, it additionally augments it with a MAC calculated based on the attributes in the PTE entry resulting from the page table walking process as shown in Step (3) of FIG. 4. Similar to conventional IOMMU with ATS enabled, the accelerator will be provided with the translation information to cache internally, however in CryptoMMU, the MAC of the translation entry is also provided as in Step (4) of FIG. 4.

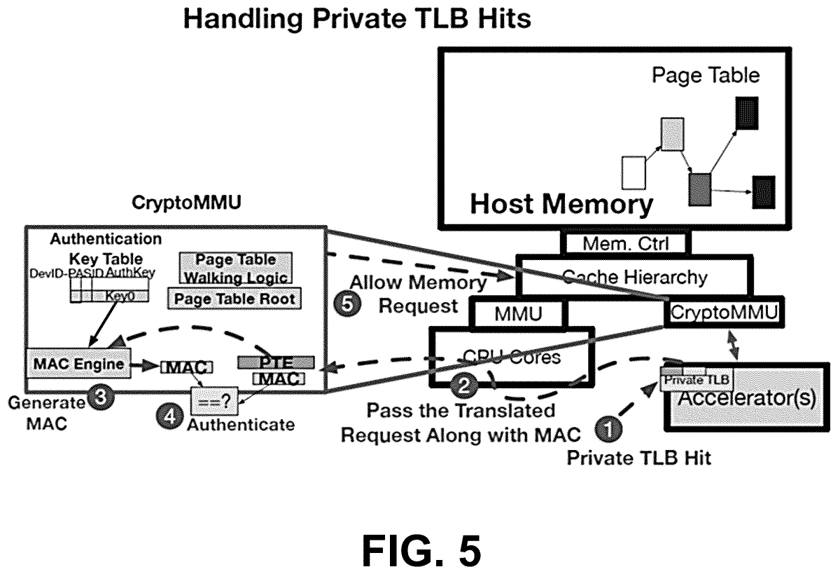

As shown in FIG. 5, upon a hit in a private TLB (Step (1) of FIG. 5), the accelerator is prevented from directly using this pre-translated address to access the system memory without IOMMU check. Hence, the accelerator needs to send the request containing both the physical address (along with access permissions) and the MAC for authentication to the IOMMU, as shown in Step (2) of FIG. 5. CryptoMMU obtains the appropriate key from Authentication Key Table (AKT) based on the device ID (DevID) and the Process ID (PASID). The MAC engine in CryptoMMU generates a fresh MAC based on the attributes of the PTE information (physical address and permissions) provided in the accelerator's request, as shown in Step (3) of FIG. 5. The generated MAC is then compared with the MAC provided by the accelerator (Step (4) of FIG. 5). If both the MAC matches, it implies that the translation information provided has not been tampered with, and consequently, the system memory access is allowed, as shown in Step (5) of FIG. 5. If a malicious accelerator tampers with the physical address or the permissions in its private TLB, then the MAC authentication will fail. Moreover, tempering with the MAC values cached in the private TLB will also result in access failure, as discussed in the Background Section above.

Allocating AKT Entries: CryptoMMU utilizes a single authentication key per {accelerator, PASID} to ensure isolation. There are different options to realize such keys and store them. However, in CryptoMMU, the aim is to achieve the following: (1) minimal IOMMU latency for verifying I/O requests with translated addresses and (2) no software changes. Accordingly, the CryptoMMU can be responsible for creating the keys and book-keeping them. To do so, CryptoMMU can use a hardware table tagged with the Device ID and Process ID. Such hardware table is dubbed as Authentication Key Table (AKT). The AKT leverages the unused IOTLB structure in IOMMU (since private TLBs are used), and hence features a very fast access time. The AKT used in CryptoMMU can be a 64-entry fully-associate buffer, which is sufficient to allow 64 active {accelerator, process} sessions to leverage CryptoMMU. Upon a miss in AKT, CryptoMMU checks if there exist any invalid entries and then replaces them with a newly-generated authentication key corresponding to the {accelerator, PASID}. However, if there are no invalid entries, two options are available: (a) avoid evicting valid entries and instead use conventional IOMMU implementation, i.e., discard the provided physical address and do the translation at CryptoMMU, or (b) use Least-Recently Used (LRU) policy to select a victim entry. While option (b) allows active sessions to be evicted, it can potentially lead to frequent key changes for the same session if more than 64 sessions are actively accessing the host memory. Although it is believed to be uncommon, if that is anticipated in the system, CryptoMMU can be allowed to be configured using option (a) or option (b) but with an additional space reserved at the bootup time in memory acting as a victim buffer for evicted sessions. Without such a buffer changing key of an active session renders all cached translations of that session causing verification failure and hence reverting to baseline IOMMU. In other words, it implicitly flushes the privately cached translations of the session corresponding to the evicted and then re-generated entry. The eviction table reserved at host memory during the bootup time was assumed to be 1 MB for the whole system, which allows having hundreds of thousands of active sessions without the need to change the authentication key for a session.

MAC Calculation Granularity: The MAC algorithm used in the CryptoMMU design, to generate the authentication tags, can use Wegman-Carter style hash functions to hash the PTE entries. The PTE value is padded with zeros to match the input size needed by the hash algorithm before calculating the hash. The hash function can be selected from a family of hash functions using a 512-bit input (i.e., hash key). The algorithm used can take a nonce in addition to the data input to generate a 56-bit output. Thus, the contents of the PTE entry were padded with zeros to make a 512-bit block, and use the virtual address as a nonce to generate the MAC. Since each {accelerator, process} has a unique authentication key, even for the same virtual address and physical address, but another accelerator, a different MAC is generated, and thus isolation will be enforced. Note that in some MAC algorithms, no nonce is required, and hence using the virtual address as a nonce in the Wegman-Carter MAC scheme is implementation-specific. Nonetheless, the choice of using a virtual address as a nonce is to eliminate the need to generate and book-keep a nonce along with each authentication key. To store the MACs in private TLBs, it is assumed that future accelerators can be designed with each TLB entry sized to contain the PTE (8 bytes) and the corresponding MAC (7 bytes). How to potentially avoid such changes to the TLB structure in legacy accelerators will be discussed in a latter section.

### Supporting CryptoMMU in Legacy Accelerators

As discussed earlier, the baseline CryptoMMU design needs a slight modification in the accelerator's TLB design to cache the security-related metadata (MACs, namely) and to also communicate such metadata along with IOMMU requests. Although feasible for future accelerators, it needs changes to the hardware and is hence not suitable for legacy designs. In order to support legacy designs, another flavor of CryptoMMU is proposed, CryptoMMU-Legacy. Since the upper bits of the physical page are unused in PTE, these bits can be used to place a truncated Message Authentication Codes. For example, the Intel Core i7 uses 52 bits for physical pages. A system with 512 GB of physical memory would use 27 bits of 52 available bits, which leaves 25 unused bits. The CryptoMMU design generates a MAC over the PTE entry using a key corresponding to {accelerator, process} and then truncates it down to 25 bits and stores it in the PTE.

Security Analysis: To fully understand the security guarantees provided by CryptoMMU in the legacy accelerator system. The probability of any malicious accelerator breaching the security boundaries set by CryptoMMU was analyzed. As discussed earlier, a truncated MAC will provide sufficient security guarantees for the legacy accelerator system. The probability of malicious access in a system with a 25-bit is 2.9×10⁻⁸, which is much higher than the acceptable probability of memory access violations in currently deployed systems. For example, Arm's Pointer Authentication techniques that are used in commercial products like Apple iphone XS for address verification have introduced special instructions to sign and verify pointers. These instructions internally generate a pointer authentication code (PAC), a type of MAC, and store it in unused bits of virtual memory. For verification, special instructions are used to recompute the PAC and compare it with the stored authentication code.

The probability of guessing the right values of PAC depends on the size of the PAC code. The PAC code can be as low as 3 bits with an access violation probability of 0.125 in AArch64 to 24 bits with a violation probability of 2.5×10⁻⁷ in Linux. Moreover, a 52-bit virtual address can have a PAC size of 11 bits and a probability of 4.9×10⁻⁴ to guess the right PAC. Even though pointer authentication codes were developed for memory isolation within the same address space and for a different threat model, these probabilities are acceptable for any potential access violation in commercial systems. Similarly, software approaches like ARM's Memory Tagging Extensions (MTE) and ARM's Top-byte Ignore (TBI) use 4 bits and 8 bits, respectively, and have an even higher probability of access violations. Therefore, this probabilistic solution of memory access violation in CryptoMMU, which has a much higher probability of denying arbitrary memory requests from external accelerators in the currently deployed system, can be safely adopted.

### TLB Maintenance Operations

A potential problem that can arise in the CryptoMMU design is TLB shootdowns in accelerator private TLB when a PTE is changed by the Operating System. However, a malicious accelerator might retain the translation along with its corresponding MAC, and tries to use it for a later access even though the page access was revoked. When the OS changes the page mappings, it sends an invalidation request to all the TLBs of the impacted accelerators. In order to stop accelerators from using any stale translations, CryptoMMU will just change the authentication key corresponding to {accelerator, Process} and send a TLB flush request to the affected accelerator.

Now, if the accelerator tries to access the memory with a stale translation, the MAC authentication will fail because the MAC generated using the new keys will never match the provided MAC. Thus, unauthorized access attempts will fail. To enable more scalability, if a verification fails, then the regular page table walking can be used for that translation and a shootdown of the translation issued. Later misses will bring in the PTE authenticated using the new key. Alternatively, an error can be reported since the device still attempted to use a translation which is supposed to be flushed.

### IOMMU for FPGA Accelerators

The modern SoCs like ZynqUS+ have a full-fledged hardware IOMMU, that can support address translation for accelerators. These hard-IOMMU can provide virtual memory support for accelerators deployed on FPGA fabric. These IOMMU features a hardware page table walker and an IOTLB. They also proposed a software component running on the host that interface user-space application with standard kernel-level drivers for IOMMU for efficient address translation service. Since this design deploys the IOMMU on the FPGA fabric, it is not a secure design. Any tempering to the FPGA fabric will compromise the security of whole system.

### Secure Virtual Memory Support for Accelerators

Modern processors are equipped with IOMMU to support efficient address translation and prevent memory attacks from general purpose IO's like Ethernet Controller, PCIe SSD controller and accelerators like GPUs. Previous work has focused on improving IOMMU capabilities for performance and security, however they are not intended for customized accelerators. A sandboxing mechanism has been proposed to protect system from unauthorized memory access from external accelerators. It proposed a mechanism to guarantee access control to the page table while maintaining high performance with low storage overhead, however this work is only limited to GPUs.

### Security Vulnerability in FPGA Accelerators

The flexibility and high power efficiency has made FPGAs a popular choice for accelerating deep learning algorithm. In particular, FPGAs are widely used for Machine Learning as service (MLaaS) in the cloud platforms. The attack vector for FPGA accelerators is fairly large, and a wide range of physical attacks have been studied.

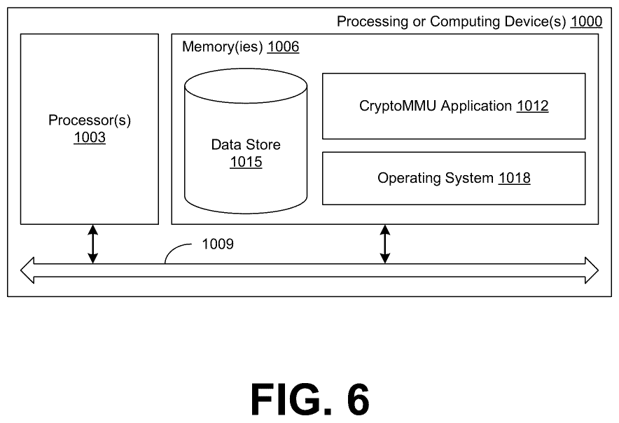

With reference next to FIG. 6, shown is a schematic block diagram of a processing or computing device 1000. In some embodiments, among others, the computing device 1000 may represent one or more computing devices (e.g. a computer, server, tablet, smartphone, etc.). Each processing or computing device 1000 includes at least one processor circuit, for example, having a processor 1003 and a memory 1006, both of which are coupled to a local interface 1009. To this end, each processing or computing device 1000 may comprise, for example, at least one server computer or like device, which can be utilized in a cloud-based environment. The local interface 1009 may comprise, for example, a data bus with an accompanying address/control bus or other bus structure as can be appreciated.

In some embodiments, the processing or computing device 1000 can include one or more network interfaces. The network interface may comprise, for example, a wireless transmitter, a wireless transceiver, and/or a wireless receiver (e.g., Bluetooth®, Wi-Fi, Ethernet, etc.). The network interface can communicate with a remote computing device using an appropriate communications protocol. As one skilled in the art can appreciate, other wireless protocols may be used in the various embodiments of the present disclosure.

Stored in the memory 1006 are both data and several components that are executable by the processor 1003. In particular, stored in the memory 1006 and executable by the processor 1003 are at least one CryptoMMU application 1012 and potentially other applications and/or programs. Also stored in the memory 1006 may be a data store 1015 and other data. In addition, an operating system 1018 may be stored in the memory 1006 and executable by the processor 1003.

It is understood that there may be other applications that are stored in the memory 1006 and are executable by the processor 1003 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 1006 and are executable by the processor 1003. In this respect, the term “executable” means a program or application file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores and the memory 1006 may represent multiple memories 1006 that operate in parallel processing circuits, respectively, such as multicore systems, FPGAS, GPUs, GPGPUs, spatially distributed computing systems (e.g., connected via the cloud and/or Internet). In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, performing load balancing. The processor 1003 may be of electrical or of some other available construction.

Although the CryptoMMU application 1012 and other applications/programs, described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the CryptoMMU application 1012 and other applications/programs, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the CryptoMMU application 1012 and other applications/programs, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same processing or computing device 1000, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for cryptographic memory management, comprising:
receiving, by a cryptographic memory management unit (CryptoMMU), a request identified as a private translation-lookaside buffer (TLB) miss or hit from an accelerator;
in response to the TLB hit, generating a message authentication code (MAC) based upon attributes of a page table entry (PTE) corresponding to the request;
comparing the generated MAC to a MAC provided with the request; and
in response to the comparison, allowing system memory access if the generated MAC matches the MAC provided with the request.

2. The method of claim 1, wherein system memory access is denied if the generated MAC does not match the MAC provided with the request.

3. The method of claim 1, wherein the request comprises the attributes of the PTE.

4. The method of claim 1, wherein generating the MAC comprises determining a key from an authentication key table (AKT) based at least in part upon a device identifier (DevID) associated with the accelerator and a process address space identifier (PASID).

5. The method of claim 1, further comprising:
in response to the TLB miss, obtaining a page table entry (PTE) based upon a page table in host memory corresponding to the private TLB miss;
determining message authentication code (MAC) based upon attributes of the PTE; and
providing the accelerator with translation information comprising the PTE and the determined MAC, the translation information enabling access by the accelerator.

6. The method of claim 5, wherein the PTE is obtained by walking through the page table.

7. A system for cryptographic memory management, comprising:
at least one processing or computing device comprising processing circuitry, the at least one processing or computing device configured to at least:
receive, by a cryptographic memory management unit (CryptoMMU) of the at least one processing or computing device, a request identified as a private translation-lookaside buffer (TLB) miss or hit from an accelerator;
in response to the TLB hit, generate a message authentication code (MAC) based upon attributes of a page table entry (PTE) corresponding to the request;
compare the generated MAC to a MAC provided with the request; and
in response to the comparison, allow system memory access if the generated MAC matches the MAC provided with the request.

8. The system of claim 7, wherein system memory access is denied if the generated MAC does not match the MAC provided with the request.

9. The system of claim 7, wherein the request comprises the attributes of the PTE.

10. The system of claim 7, wherein generating the MAC comprises determining a key from an authentication key table (AKT) based at least in part upon a device identifier (DevID) associated with the accelerator and a process address space identifier (PASID).

11. The system of claim 7, wherein the at least one processing or computing device is further configured to:
in response to the TLB miss, obtain a page table entry (PTE) based upon a page table in host memory corresponding to the private TLB miss;
determine message authentication code (MAC) based upon attributes of the PTE; and
provide the accelerator with translation information comprising the PTE and the determined MAC, the translation information enabling access by the accelerator.

12. The system of claim 11, wherein the PTE is obtained by walking through the page table.

13. The system of claim 7, wherein a trusted computing base comprises the at least one processing or computing device.

14. A non-transitory computer-readable medium embodying a program executable in at least one computing device, where when executed the program causes the at least computing device to at least:
receive, by a cryptographic memory management unit (CryptoMMU) of the at least one processing or computing device, a request identified as a private translation-lookaside buffer (TLB) miss or hit from an accelerator;
in response to the TLB hit, generate a message authentication code (MAC) based upon attributes of a page table entry (PTE) corresponding to the request;
compare the generated MAC to a MAC provided with the request; and
in response to the comparison, allow system memory access if the generated MAC matches the MAC provided with the request.

15. The non-transitory computer-readable medium of claim 14, wherein system memory access is denied if the generated MAC does not match the MAC provided with the request.

16. The non-transitory computer-readable medium of claim 14, wherein the request comprises the attributes of the PTE.

17. The non-transitory computer-readable medium of claim 14, wherein generating the MAC comprises determining a key from an authentication key table (AKT) based at least in part upon a device identifier (DevID) associated with the accelerator and a process address space identifier (PASID).

18. The non-transitory computer-readable medium of claim 14, wherein the program, when executed, causes the at least one processing or computing device to:
in response to the TLB miss, obtain a page table entry (PTE) based upon a page table in host memory corresponding to the private TLB miss;
determine message authentication code (MAC) based upon attributes of the PTE; and
provide the accelerator with translation information comprising the PTE and the determined MAC, the translation information enabling access by the accelerator.

19. The non-transitory computer-readable medium of claim 18, wherein the PTE is obtained by walking through the page table.
